(19) United States
(12) Patent Application Publication
(10) Pub. No.: US 2026/0054627 A1
(43) Pub. Date: Feb. 26, 2026

(54) SEAT PROVIDED WITH A DEVICE FOR RETRACTING A HEADREST

(71) Applicant: Safran Seats, Plaisir (FR)

(72) Inventor: Jean-Noël Bonnin, Moissy-Cramayel (FR)

(21) Appl. No.: 19/133,615

(22) PCT Filed: Nov. 29, 2023
(86) PCT No.: PCT/EP2023/083600

§ 371 Date: Nov. 4, 2025

(30) Foreign Application Priority Data
Dec. 2, 2022 (FR) FR2212668

(51) Int. Cl. B60N 2/832; B60N 2/34; B60N 2/879

(52) U.S. Cl. CPC B60N 2/832; B60N 2/34; B60N 2/879

(57) ABSTRACT

The invention relates to a seat comprising:
a squab, and
a backrest provided with a headrest movable with respect to the backrest, said backrest being movable rotationally with respect to the squab and translationally with respect to at least one upright of a seat structure when the seat moves between a sitting position and a stretched-out position,
a retraction device for the headrest comprising a return member arranged between the backrest and the upright and also a cable mechanically connected to the headrest, said retraction device being configured to allow a dead travel of the return member between the sitting position and a predefined intermediate position of the seat and then in order that the return member generates, on account of the relative translational movement of the backrest with respect to the upright, a pull on the cable causing the retraction of the headrest inside a receiving space provided in the backrest after consumption of the dead travel, between the intermediate position and the stretched-out position of the seat.

The present invention relates to a seat provided with a retraction device for a headrest. The invention finds a particularly advantageous, but not exclusive, application with seat units of “business class” and “first class” types in an aircraft cabin. The invention can also be implemented with seats to be installed inside other vehicles, in particular motor vehicles or ships.

In a manner known per se, such a seat unit comprises a seat associated with a privacy shell extending at least partly around the seat so as to delimit a semi-enclosed space around the passenger. Such a configuration permits to guarantee the passenger's privacy.

The seat offers the passenger different comfort positions, from a “sitting” position to a “lying” position, in which a seating pan and a seat back define a substantially horizontal sleeping surface for the passenger to lie down thereon. Intermediate comfort positions are also available, such as the “reclining” position in which the seat back is very much tilted backward. Generally, these intermediate positions are achieved by tilting the pivoting backrest around a horizontal axis perpendicular to an extension axis of the seat.

The backrest can be provided with a headrest which can be moved in translation relative to the backrest between a deployed position and a retracted position. The passenger can thus adjust the height of the headrest according to the position of her/his head on the seat. When the seat moves towards the lying position, the headrest in the deployed position is likely to interfere with the privacy shell. There is therefore a risk of damaging the headrest, particularly when the latter is equipped with speakers whose electronics must be protected from any type of impact with the seat environment.

The aim of the invention is to effectively remedy this drawback by offering a seat comprising:
a seating pan, and
a backrest provided with a headrest movable relative to the backrest, said backrest being movable in rotation relative to the seating pan and in translation relative to at least one upright of a seat structure when the seat moves between a seating position and a lying position,
a retraction device for the headrest comprising a return member between the backrest and the upright as well as a cable mechanically linked to the headrest, said retraction device being configured so as to allow a dead travel of the return member between the £ seating position and a predefined intermediate position of the seat, then so that the return member generates, due to the relative movement in translation of the backrest with respect to the upright, a traction on the cable, causing thereby the retraction of the headrest into a reception space in the backrest, at the end of the dead travel, between the intermediate position and the lying position of the seat.

The invention thus permits, thanks to the presence of the retraction device for the headrest, to move the headrest away from the privacy shell of the seat when the latter moves from the sitting position to the lying position. The invention thus avoids any risk of interference between the headrest and the privacy shell.

According to one embodiment of the invention, the return member comprises a cable guide associated with a cable stop fixed to a first end of the cable, said cable having

between the cable guide and the cable stop an overtravel corresponding to the dead travel so that, at the end of the dead travel, the cable stop bears against the cable guide so as to generate the traction of the cable causing the retraction of the headrest.

According to one embodiment of the invention, a second end of the cable is mechanically linked to a carriage fixed to the headrest, said carriage being able to slide inside a groove in the backrest between a high position and a low position corresponding to a retracted position of the headrest.

According to one embodiment of the invention, at least one return spring is mounted between the carriage and the backrest.

According to one embodiment of the invention, in order to avoid buttressing, two return springs are mounted between the carriage and the backrest.

According to one embodiment of the invention, a limit-of-travel spring is mounted between the upright and the cable guide so as to absorb the limit of travel of the backrest until it reaches the lying position.

According to one embodiment of the invention, a stiffness of the limit-of-travel spring is greater than an equivalent stiffness of the return spring(s).

According to one embodiment of the invention, the cable guide is mechanically linked to a piston capable of sliding inside a guide support fixed to the upright.

According to one embodiment of the invention, a sleeve fixed to the cable guide is provided for covering the cable

According to one embodiment of the invention, the return member is a pinion mechanically linked to the backrest and provided for cooperating with a rack fixed on the upright, said pinion being coupled to a pulley mechanically linked to the cable, said pinion carrying a stud capable of sliding inside a circular slot in the pulley, said circular slot corresponding to the dead travel.

According to one embodiment of the invention, a spiral spring (or wrap spring), has a first end rotatably linked to the pulley and a second end rotatably linked to a platform so as to absorb a limit of travel of the backrest up to the lying position.

According to one embodiment of the invention, the cable has a stop at its end inside a housing made in the pulley.

According to one embodiment of the invention, said seat comprises an actuator capable of automatically moving the seat from the sitting position to the lying position.

According to one embodiment of the invention, the headrest is provided with loudspeakers.

The invention also relates to a seat unit comprising a seat as previously defined and a shell extending at least partly around the seat.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

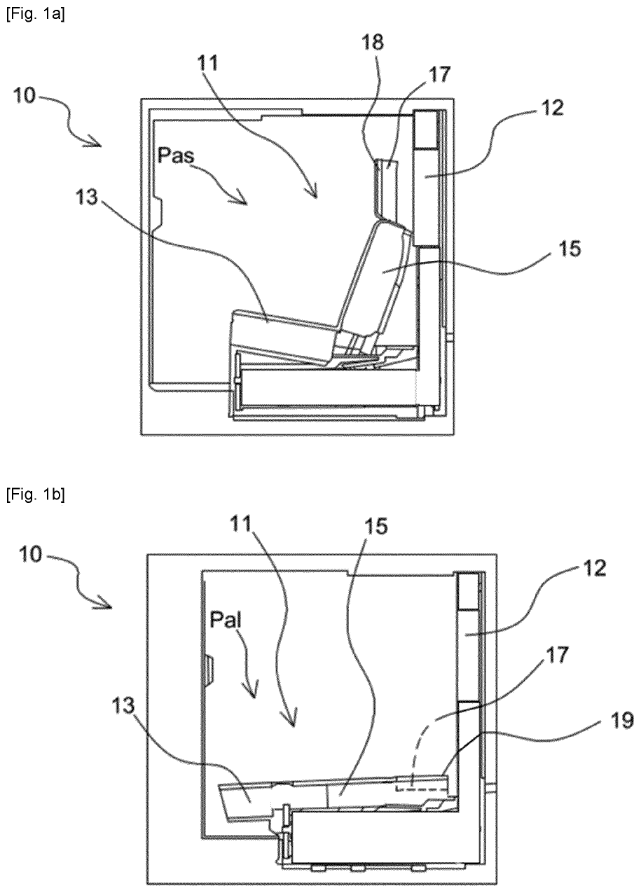

FIGS. 1a and 1b are side views of a seat unit according to the invention respectively in the sitting position and in the lying position;

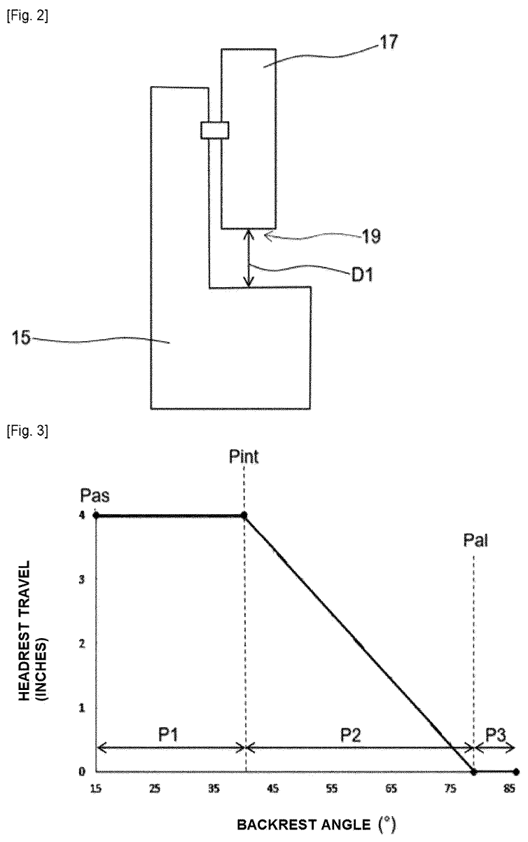

FIG. 2 is a schematic representation of a headrest movable in translation relative to the back of the seat according to the invention;

FIG. 3 is a graphical representation of the retraction travel of the headrest as a function of the inclination of the backrest when the seat according to the invention moves from a seating position to a lying position;

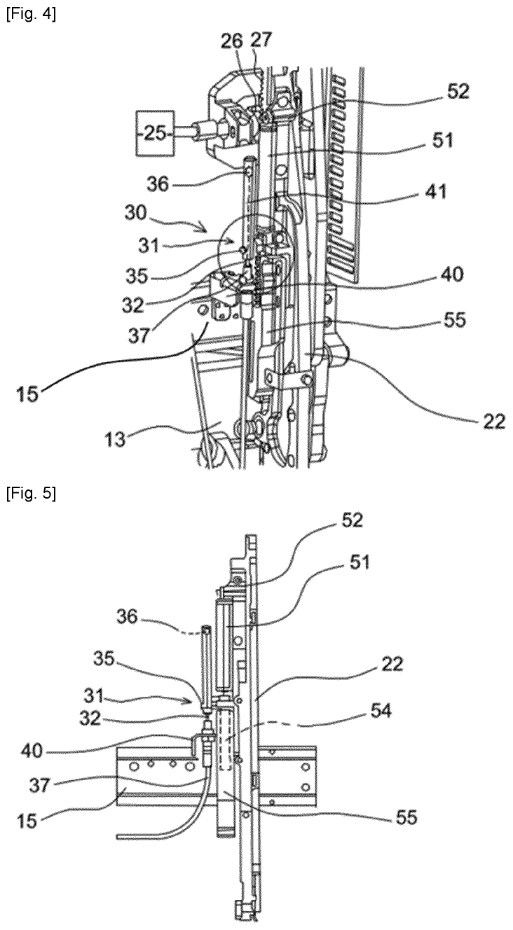

FIG. 4 is a perspective view of the components of a retraction device for a headrest according to the invention behind the back of the seat;

FIG. 5 is a front view of the components of the retraction device for a headrest according to the invention behind the back of the seat;

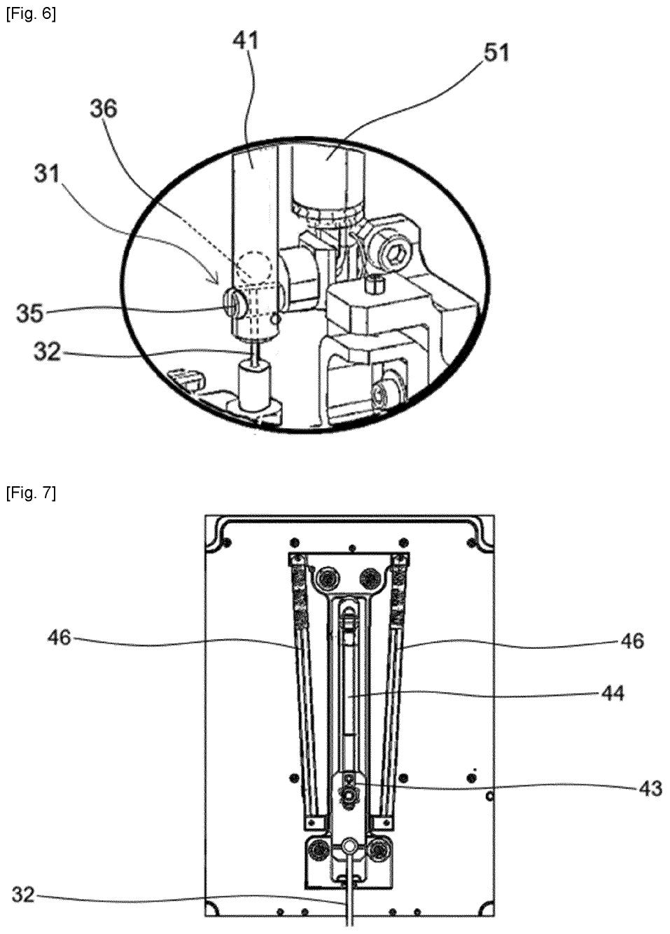

FIG. 6 is a detailed perspective view illustrating the connection between the limit-of-travel spring and the cable guide of the retraction device for a headrest according to the invention;

FIG. 7 is a front view of a carriage of the retraction device for a headrest according to the invention capable of sliding inside a groove in the backrest;

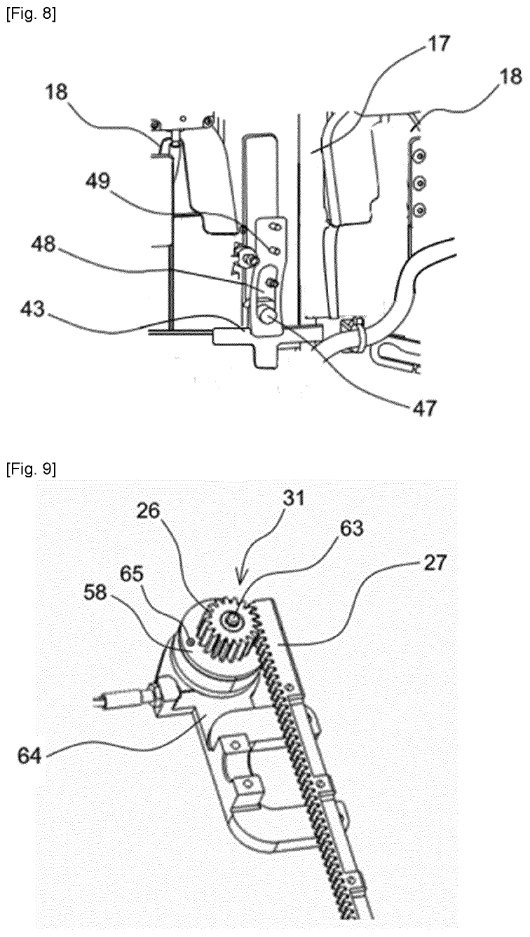

FIG. 8 is a perspective view illustrating the mechanical connection of the carriage in FIG. 7 with the headrest of the seat according to the invention;

FIG. 9 is a perspective view of a second embodiment of the retraction device for a headrest according to the invention;

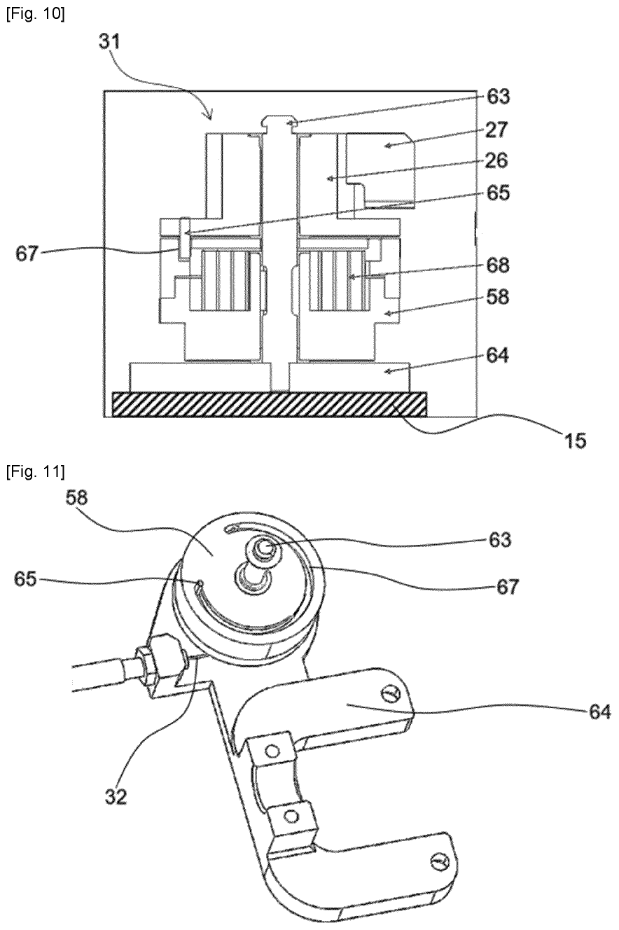

FIG. 10 is a sectional view of the retraction device for a headrest in FIG. 9;

FIG. 11 is a perspective view of the retraction device for a headrest in FIG. 9 without the drive pinion;

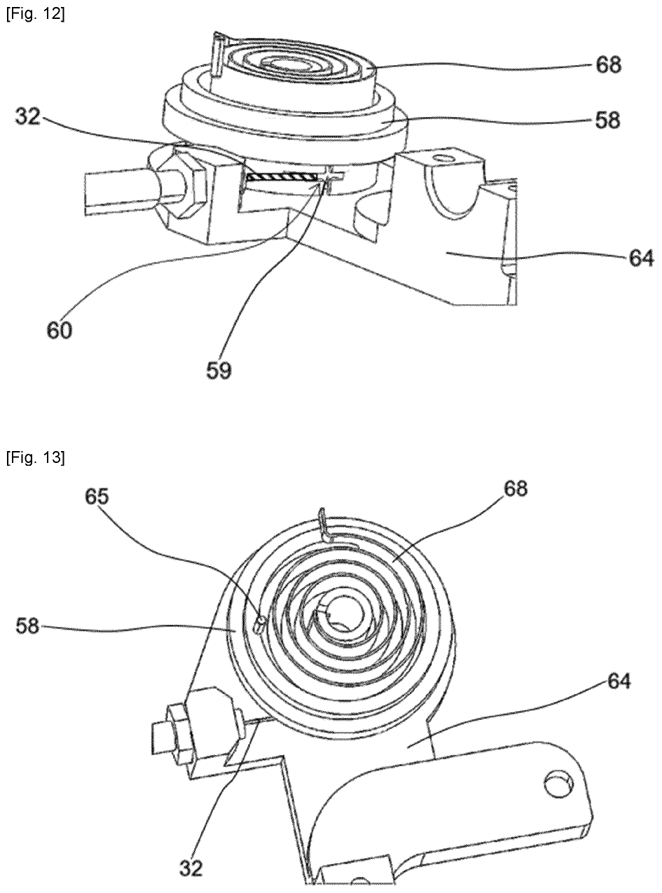

FIG. 12 is a perspective view showing the mechanical connection between the cable and the pulley of the retraction device for a headrest of FIG. 9;

FIG. 13 is a perspective view showing the limit-of-travel spring between the pulley and the platform of the retraction device for a headrest of FIG. 9.

It should be noted that, in the figures, the structural and/or functional elements common to the different embodiments have the same references. Thus, unless otherwise stated, such elements have identical structural, dimensional and material properties.

In the following description, the relative terms such as sitting position Pas, lying position Pal, intermediate position Pint are understood by reference to their common meaning that a person in a seat according to the invention would give them.

FIGS. 1a and 1b show a seat unit 10 comprising a seat 11 associated with a privacy shell 12 extending at least partly around of the seat 11 so as to delimit a semi-enclosed space around the passenger. Such a configuration permits to guarantee the privacy of the passenger in the seat 11.

More precisely, the seat 11 comprises a seating pan 13 and a backrest 15 provided with a headrest 17 movable in translation relative to the backrest 15. The headrest 17 may be provided with loudspeakers 18. As illustrated in FIG. 2, the headrest 17 is movable in translation along a direction D1 between a deployed position in which the headrest 17 projects at least partly relative to an upper end face of the backrest 15 and a retracted position in which the headrest 17 is set back from or flushes with the upper end face of the backrest 15. For this purpose, the backrest 15 comprises a receiving space 19 for the headrest 17 when the latter is in the retracted position.

The seat 11 is advantageously provided with a kinematics allowing to be movable between a “seating” position in which the seat 11 is configured to define a “seating” position Pas of a passenger, and a “lying” position Pal in which the seating pan 13 and the backrest 15 define a sleeping surface for the passenger, advantageously substantially horizontal. According to an exemplary embodiment, the backrest 15 can form an angle with a vertical plane between 10 and 25 degrees when the seat 11 is in the seating position Pas. The backrest 15 can form an angle with a vertical plane between 80 and 90 degrees when the seat 11 is in the lying position Pal.

The seat 11 can also take at least one intermediate comfort position Pint, called the “reclining” position, in which the backrest 15 of the seat 11 is strongly inclined backwards. In a predetermined intermediate position Pint in which the backrest 15 is close to the privacy shell 12, the backrest 15 can form an angle with a vertical plane between 35 and 55 degrees.

In order that the seat 11 be able to move from the “sitting” position Pas to the “lying” position Pal, the backrest 15 is mounted so as to be mobile in rotation relative to the seating pan 13 and mobile in translation relative to a seat structure. More precisely, the backrest 15 is mounted so as to be mobile in translation on at least one upright 22 of the seat structure, which is able to rotate relative to the seating pan 13. For this purpose, a sliding system is arranged between the backrest 15 and the upright 22. In addition, a pivot connection is interposed between the upright 22 and the seating pan 13.

Advantageously, the movement of the seat 11 from one position to another is carried out by an actuator 25, in particular an actuator with an electric motor or a hydraulic or pneumatic gas cylinder or a linear motor, driving a pinion 26 mounted on the backrest 15 and meshing with a rack 27 fixed on the upright 22.

According to a kinematic known per se in which the seating pan 13 is mounted on rails in the seat structure, an activation of the actuator 25 causes the seating pan 13 to move forward and the backrest 15 to tilt backward in order to move the seat 11 from the “sitting” position Pas to the “lying” position Pal in FIG. 1b. Alternatively, the seat 11 can be moved from one position to another manually by applying a backward force to the backrest 15 after unlocking the seat 10.

A retraction device 30 of the headrest 17 comprises a return member 31 between the backrest 15 and the upright 22 of the seat structure as well as a cable 32 mechanically linked to the headrest 17. The retraction device 30 is configured so as to allow a dead travel of the return member 31 between the “seating” position Pas and the predefined “intermediate” position Pint of the seat 11. During the dead travel, the headrest 17 remains in its initial position and the return member 31 does not generate traction on the cable 32.

The retraction device 30 is also configured so that the return member 31 generates, due to the relative displacement in translation of the backrest 15 with respect to the upright 22 of the seat structure, a traction on the cable 32, causing thereby the retraction of the headrest 17 into the reception space 19 in the backrest 15, at the end of the dead travel, between the “intermediate” position Pint and the “lying” position Pal of the seat 11.

FIG. 3 is a graphical representation of the retraction travel of the headrest 17 as a function of the inclination of the backrest 15 when the seat 11 according to the invention moves from a “sitting” position Pas to a “lying” position Pal. FIG. 3 shows that over a first angular range of inclination P1 of the backrest 15 corresponding to the movement of the seat 11 from the “sitting” position Pas to the “intermediate” position Pint, the headrest 17 remains in the deployed position. Over a second angular range of inclination P2 of the backrest 15, the headrest 17 is moved to its retracted position due to the traction on the cable 32 generated by the return member 31. Over the third angular range of inclination P3 of the backrest 15, the headrest 17 remains in the retracted position. As explained below, a limit-of-travel spring 51 can be used to absorb the end of travel of the backrest 15. The retraction travel of the headrest 17 is for example 4 inches (102 mm).

In the embodiment of FIGS. 4, 5, and 6, the return member 31 comprises a cable guide 35 associated with a cable stop 36 fixed to a first end of the cable 32. A sheath 37 of the cable 32 is fixed to the backrest 15 by means of a connecting piece 40, formed for example by a sheet metal fixed to the backrest 15. The cable 32 has an overtravel between the cable guide 35 and the cable stop 36, which corresponds to the dead travel, so that, at the end of the overtravel, the cable stop 36 bears against the cable guide 35 so as to generate the traction on the cable 32 causing thereby the retraction of the headrest 17. For this purpose, the cable guide 35 comprises a slot whose width is greater than or equal to the diameter of the cable 32 and less than a dimension of the cable stop 36, in particular a diameter of the cable stop 36 in the case where the cable stop 36 takes the form of a ball. A sleeve 41 fixed on the cable guide 35 is provided so as to cover the cable overtravel 32.

As illustrated in FIG. 7, a second end of the cable 32 is mechanically linked to a carriage 43 fixed to the headrest 17. The carriage 43 is able to slide inside a groove 44 in the backrest 15 between a high position corresponding to the deployed position of the headrest 17 and a low position corresponding to the retracted position of the headrest 17. At least one return spring 46 is mounted between the carriage 43 and the backrest 15. In this case, two return springs 46 are provided on either side of the carriage 43. The carriage 43 comprises a pin 47 inserted into a groove 48 in a blade 49 secured to the headrest 17, as can be seen in FIG. 8.

A limit-of-travel spring 51 is arranged between the upright 22 of the seat structure and the cable guide 35 so as to absorb an end of travel of the backrest 15 up to the “lying” position Pal. The limit-of-travel spring 51 is a helical traction spring. One end of the limit-of-travel spring 51 is fixed to the upright 22 of the seat structure by means of an additional spring support 52. Alternatively, the spring support 52 may form a single piece with the upright 22 of the seat structure.

A stiffness of the limit-of-travel spring 51 is greater than an equivalent stiffness of the return springs 46. Such a configuration allows the return spring 46 to stretch before the limit-of-travel spring 51 during movement in translation of the backrest 15 relative to the upright 22 of the seat structure.

As can be seen in FIG. 5, the cable guide 35 is mechanically linked to a piston 54 capable of sliding inside a guide support 55 fixed on the seat structure when the limit-of-travel spring 51 stretches.

The operation of the retraction device 30 of the headrest 17 is described thereafter when the seat 11 moves from the “sitting” position Pas to the “lying” position Pal. The backrest 15 tilts backwards while moving in translation relative to the upright 22 of the seat structure, which causes a relative movement of the cable guide 35 towards the cable stop 36 until the end of the cable overtravel 32. This operating situation can be observed over the angular range of inclination P1 of the backrest 15. When the seat 11 is in the “intermediate” position Pint, the cable stop 36 comes into contact with the cable guide 32, as shown in FIG. 6. This causes a pull on the cable 32 which then pulls the carriage 43. During its movement along the groove 44, the carriage 43 moves the headrest 17 from its deployed position towards the retracted position along an observable retraction travel over the angular range of inclination P2 of the backrest 15.

Once the headrest 17 is in its retracted position, the limit-of-travel spring 51 is stretched so as to absorb an end of travel of the backrest 15 up to the lying position Pal. The extension of the limit-of-travel spring 51 is observable over the angular range of inclination P3 of the backrest 15. During the extension of the limit-of-travel spring 51, the piston 54 slides inside the guide support 55.

According to a particular embodiment, for a total movement in translation of the backrest 15 relative to the upright 22 of the seat structure of 226 mm, the dead travel is 94 mm, the retraction distance of the headrest 17 is 102 mm and the end of travel absorbed by the limit-of-travel spring 51 is 30 mm. Of course, these values are given for information purposes only and may vary depending on the configuration and kinematics of the seat 11.

In the embodiment of FIGS. 9, 10, 11, 12 and 13, the return member 31 is the pinion 26 mechanically linked to the backrest 15. The pinion 26 cooperates with the rack 27 fixed on the upright 22 of the seat Structure. The pinion 26 can be rotated by an actuator 25. The pinion 26 is coupled to a pulley 58 mechanically linked to the cable 32. For this purpose, the cable 32 has a stop 59 at one of its ends. The stop 59, in this case in the form of a ball, is arranged inside a housing 60 in the pulley 58. The other end of the cable 32 is mechanically linked to the headrest 17. The cable 32 can be linked to the headrest 17 via the carriage 43 previously described.

The pinion 26 and the pulley 58 can be mounted so as to be mobile in rotation on the same axis 63 fixed on a platform 64 to be mounted on the backrest 15, as shown in FIG. 10.

The pinion 26 carries a stud 65 capable of sliding inside a circular slot 67 in the pulley 58. The circular slot 67 has a shape of a circular arc. The circular slot 67 corresponds to the dead travel of the pinion 26 until the seat 11 reaches the “intermediate”position Pint.

A spiral spring 68 or wrap spring has a first end linked in rotation to the pulley 58 and a second end linked in rotation to the platform 64. The spiral spring 68 permits to absorb an end of travel of the backrest 15 up to the “lying” position Pal.

The operation of the retraction device 30 for the headrest 17 of FIGS. 9 to 13 when the seat 11 moves from the “sitting” position Pas to the “lying” position Pal is described hereafter. When the actuator 25 is activated, the pinion 26 engaged with the rack 27 rotates about the axis 63 while moving in translation along the rack 27, while the backrest 15 tilts backwards.

During the observable dead travel over the angular range of inclination P1 of the backrest 15, the stud 65 of the pinion 26 moves freely inside the slot 67 until it abuts against an end edge of the slot 67.

Once the stud 65 abuts against the end edge of the slot 67, the pinion 26 cause the pulley 58 to rotate which has the effect of generating a traction on the cable 32, which then pulls the carriage 43. During its movement along the groove 44, the carriage 43 moves the headrest 17 from its deployed position to the retracted position along an observable retraction travel over the angular range of inclination P2 of the backrest 15.

Once the headrest 17 is in its retracted position, the spiral spring 68 winds around the axis 63 so as to absorb an end of travel of the backrest 15 up to the “lying” position Pal. The winding of the spiral spring 68 is observable over the angular range of inclination P3 of the backrest 15.

Of course, the different characteristics, variants and/or embodiments of the present invention may be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. A seat comprising:
a seating pan; and
a backrest provided with a headrest movable relative to the backrest said backrest being movable in rotation relative to the seating pan and in translation relative to at least one upright of a seat structure when the seat moves between a seating position and a lying position,
wherein a retraction device for the headrest comprises a return member between the backrest and the upright as well as a cable mechanically linked to the headrest said retraction device being configured so as to allow a dead travel of the return member between the seating position and a predefined intermediate position of the seat then so that the return member generates, due to the relative movement in translation of the backrest with respect to the upright a traction on the cable causing thereby the retraction of the headrest into a reception space in the backrest, at the end of the dead travel, between the intermediate position and the lying position of the seat.

2. The seat according to claim 1, wherein the return member comprises a cable guide associated with a cable stop fixed to a first end of the cable said cable having an overtravel between the cable guide and the cable stop which corresponds to the dead travel, so that, at the end of the dead travel, the cable stop bears against the cable guide so as to generate the traction on the cable which causes the retraction of the headrest.

3. The seat according to claim 2, wherein a second end of the cable is mechanically linked to a carriage fixed to the headrest, said carriage being able to slide inside a groove in the backrest between a high position and a low position corresponding to a retracted position of the headrest.

4. The seat according to claim 3, wherein at least one return spring is mounted between the carriage and the backrest.

5. The seat according to claim 2, wherein a limit-of-travel spring is mounted between the upright and the cable guide so as to absorb an end of travel of the backrest up to the lying position.

6. The seat according to the claim 4, wherein a stiffness of the limit-of-travel spring is greater than an equivalent stiffness of the return spring(s).

7. The seat according to claim 2, wherein the cable guide is mechanically linked to a piston capable of sliding inside a guide support fixed on the upright.

8. The seat according to claim 1, wherein the return member is a pinion mechanically linked to the backrest and provided so as to cooperate with a rack fixed on the upright said pinion being coupled to a pulley mechanically linked to the cable said pinion carrying a stud capable of sliding inside a circular slot in the pulley, said circular slot corresponding to the dead travel.

9. The seat according to claim 8, wherein a spiral spring has a first end linked in rotation to the pulley and a second end linked in rotation to a platform so as to absorb an end of travel of the backrest up to the lying position.

10. A seat unit comprising a seat defined according to claim 1 and a shell extending at least partly around the seat.
